(19) United States
(12) Patent Application Publication
(10) Pub. No.: US 2008/0178400 A1
(43) Pub. Date: Jul. 31, 2008

(54) Method and apparatus for improving trailer ramps

(76) Inventor: Bj Brown, Eubank, KY (US)

Correspondence Address: CHRIS TANNER, 85 RIO ROBLES EAST # 2101, SAN JOSE, CA, 95134, US

(21) Appl. No.: 11/657,872

(22) Filed: Jan. 25, 2007

(51) Int. Cl. B65G 69/28

(52) U.S. Cl. 14/71.1; 14/69.5; 29/428

(57) ABSTRACT

A ramp system used with a trailer for hauling heavy equipment is disclosed. The system makes the ramp easier to operate.

### FIELD OF THE INVENTION

This invention relates generally to a ramp used with a trailer for hauling heavy equipment, and more specifically to a system for making that ramp easier to operate.

### BACKGROUND OF THE INVENTION

Trailer ramps can be difficult to operate. It is necessary to open the ramp when equipment is mounted on the trailer, and when the equipment is properly in place it is then necessary to close the ramp. Some ramps come with springs that assist a user in closing the ramp. However, opening the ramps can still be difficult. Consequently, a means of reducing the force necessary for both closing and opening a trailer ramp is desired.

### SUMMARY OF THE INVENTION

It is an object of the present invention to provide a mechanism which makes a trailer ramp easier to both open as well as close. It is an additional object of the present invention to do so in way that does not interfere with normal operation and use of the ramp. These and other objects and advantages of the invention will become readily apparent as the following description is read in conjunction with the accompanying drawings.

### BRIEF DESCRIPTION OF THE DRAWINGS

FIG. 1 shows a first embodiment of the present invention located within a trailer ramp;

FIGS. 2A, 2B, 2C show three positions of the present invention;

FIGS. 3 & 4 shows more detail of the embodiment shown in FIGS. 1 and 2;

FIG. 5 shows the relationship between axles of the embodiment shown in FIGS. 1-4;

FIG. 6 shows detail of the embodiment shown in FIGS. 1-5; and

FIG. 7 shows a latch used within the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

Farm equipment is heavy, so that the trailers for hauling that farm equipment must be extremely durable. This includes the ramps which are used to drive or roll the equipment onto that trailer. However, because of the large forces applied to these ramps, these ramps can be very heavy. Although this heaviness is good for durability, it can make the ramps difficult to lift, move, open, and close.

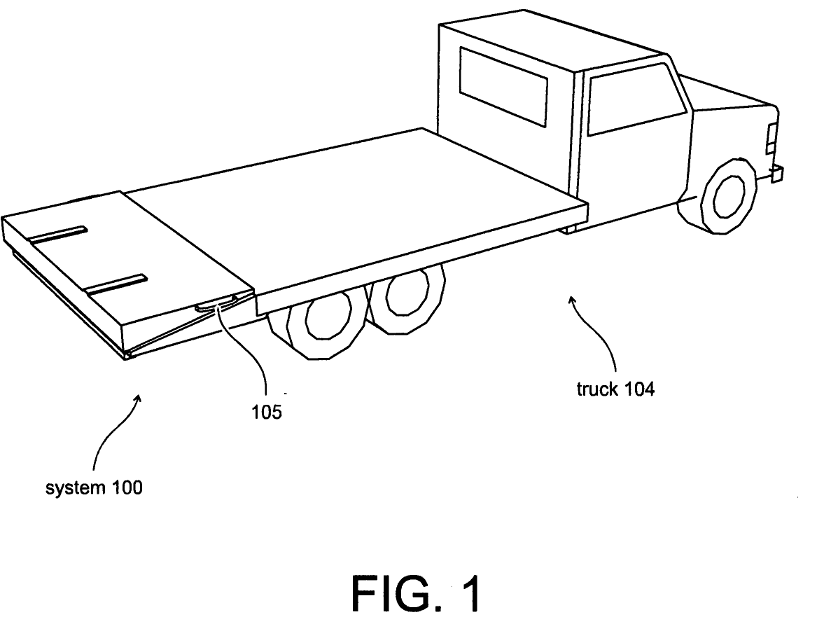

To address these and other problems, a system 100 for use within a trailer ramp of a truck 104 is disclosed in FIG. 1. The system 100 enables the ramp 101 to be more easily operated. At times, such as but not limited to during opening, the ramp 101 can be very heavy to lift, so that significant force must be applied to the handle 105.

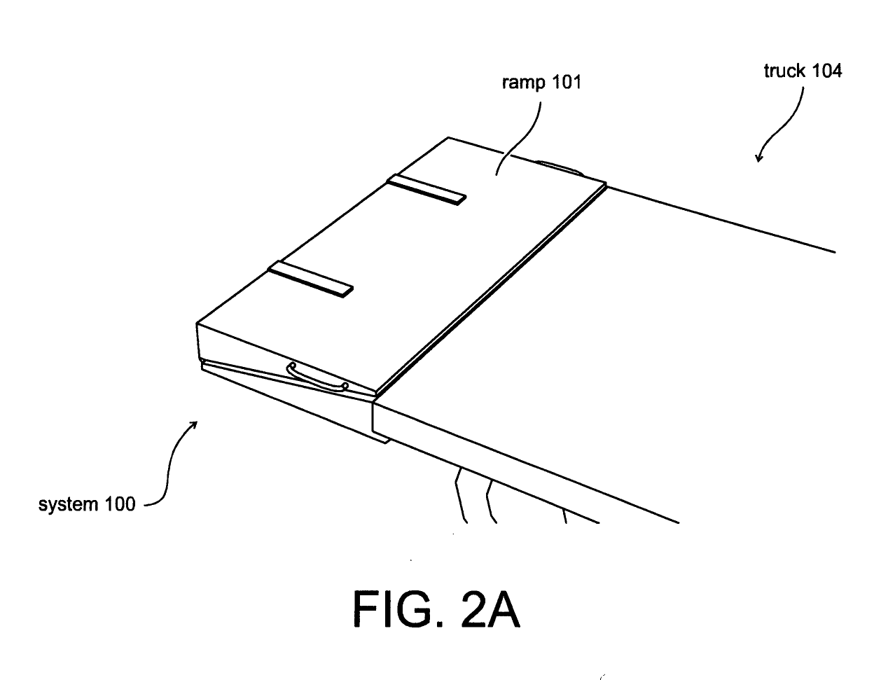

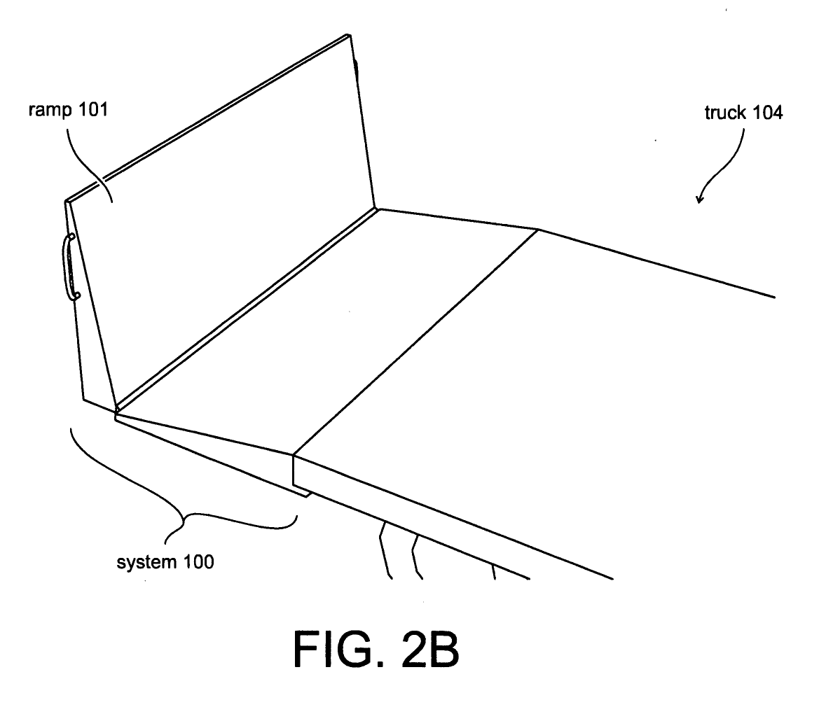

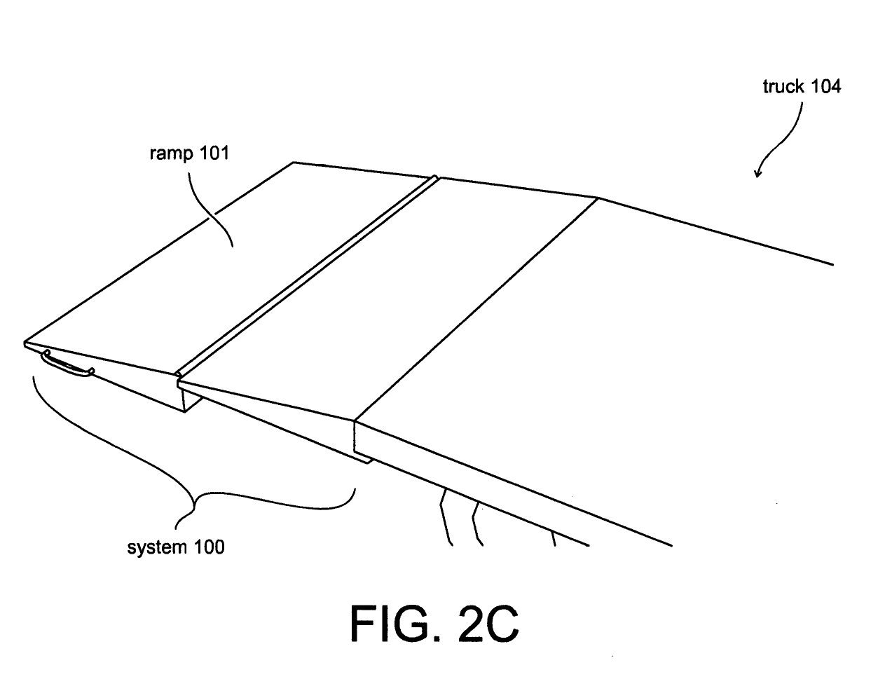

FIGS. 2A, 2B, 2C show the three main positions of operation of the ramp 101. FIG. 2A shows the ramp 101 in a closed position, and FIG. 2C shows the ramp 101 in its open position. FIG. 2B shows the ramp 101 in an intermediate position, although various details are omitted for clarity. The position shown in FIG. 2B is a type of “tipping point” of the ramp 101, where various forces within the system 100 are carefully managed.

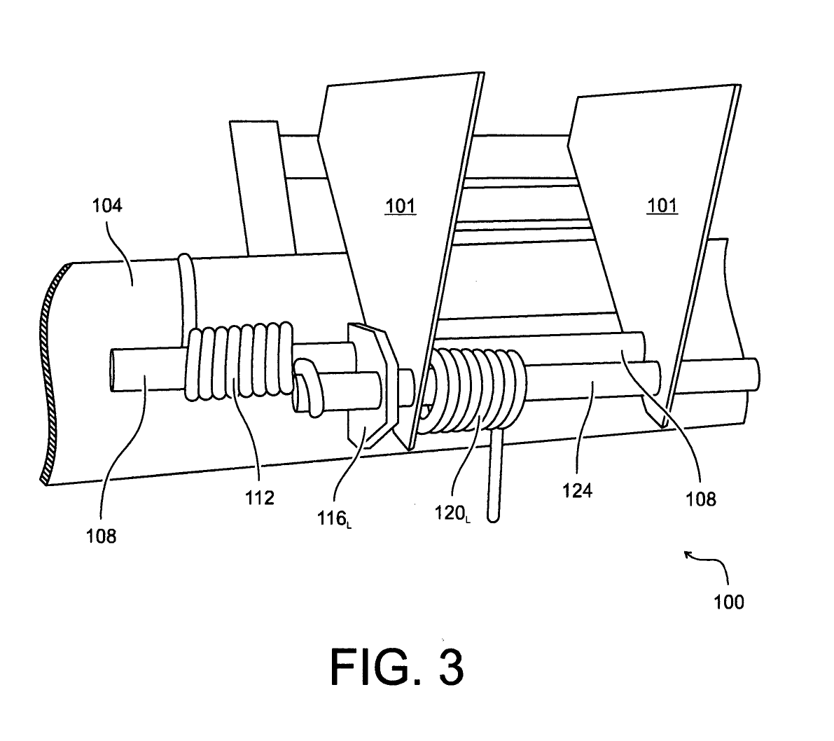

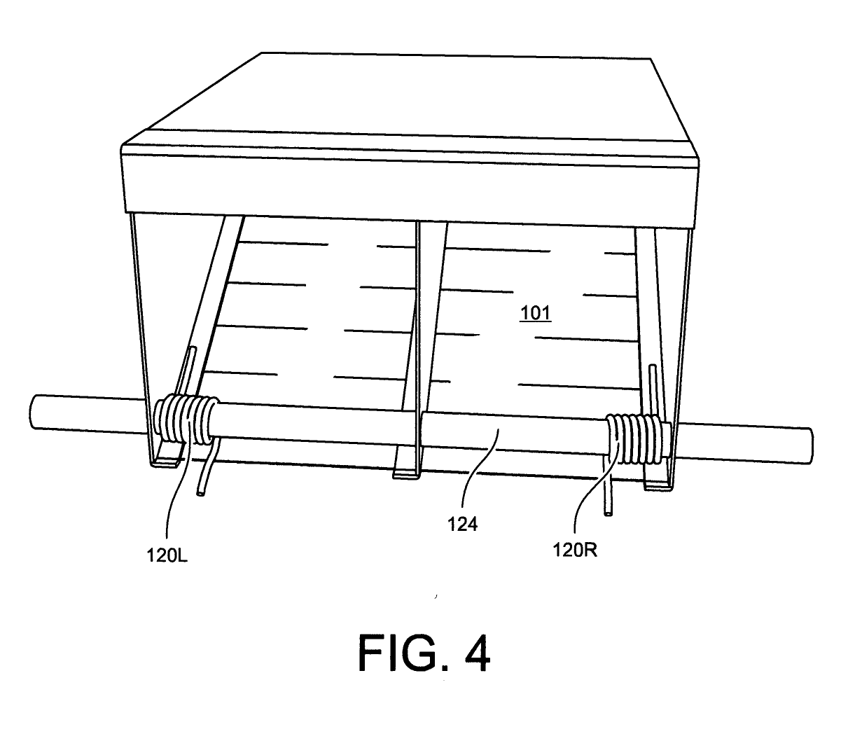

FIGS. 3 & 4 show more detail about the system 100. As stated earlier, the ramp 101 is permanently but rotatably affixed to a truck 104. The system 100 has two axles, a near axle 108 and a far axle 124. Near and far are from the perspective of the truck 104. As shown in FIG. 3, a near spring 112 ise wrapped about the near axle 108 controls tension between the ramp 104 and the far axle 124, as illustrated by one outstretched end of the spring 112 touching the truck 104, while the other outstretched end touches the axle 124. Although only a single spring 112 is shown in FIG. 3 and other figures, this is but for exemplary purposes only, so that the present invention should not be considered as limited exclusively thereto. A plurality of near springs 112 could also be incorporated into the system 100 of the present invention.

Meanwhile, as shown in FIG. 4, a pair of far springs 120_{L} and 120_{R} are wrapped about the left and right portions of the far axle 124, and control tension between the ramp 101 and the truck 104.

A pair of cams 116_{L} and 116_{R} make adjustments to the rotation of the ramp 101 about the near and far axles 108, 124. When the ramp 101 is moving between its closed position (FIG. 2A) and the tipping point (FIG. 2B), it rotates about the near axle 108. At this time, the spring 112 is in effect, but the springs 120_{L} and 120_{R} are not active. While in the tipping point position (FIG. 2B), the ramp 101 rests upon both near and far axles 108, 124. When the ramp 101 moves between the tipping point (FIG. 2B) and its open position (FIG. 2C), it rotates about the far axle 124. At this time, the spring 112 is not in effect, but the springs 120_{L} and 120_{R} are active.

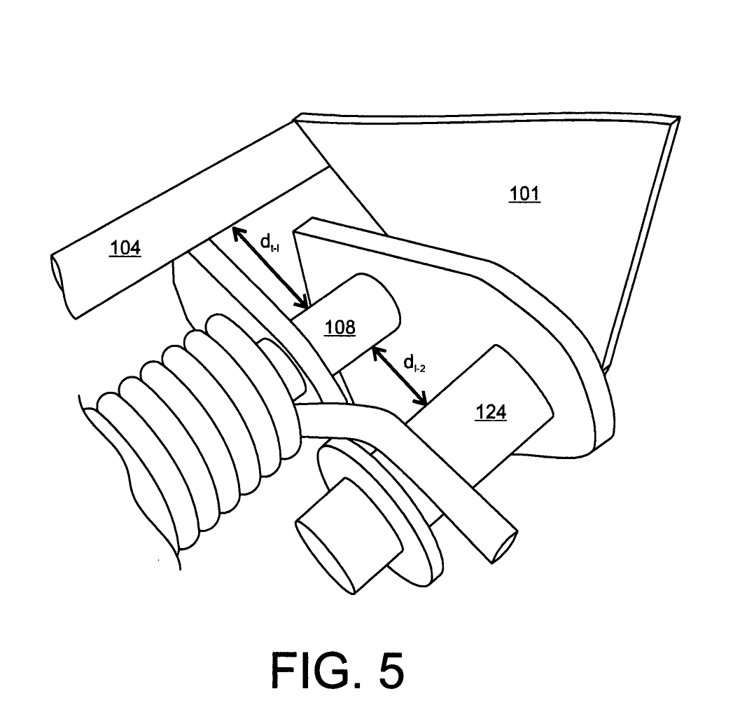

FIG. 5 shows an exemplary distance between the near (first) and far (second) axles 108, 124 respectively, which is labeled as d₁₋₂. FIG. 5 also shows an exemplary distance between the truck 104 and the near (first) axle 108, which is labeled as dₜ₋₁. If the near (first) axle 108 is too far from the far (second) axle 124, that is, if d₁₋₂is too large, the ramp 101 will tend to urge upward, and will not properly settle it place while closed. The ramp 101 will also be too hard to push down while closing. Meanwhile, if the near (first) axle 108 is too close to the far (second) axle 124, that is, if d₁₋₂ is too small, the ramp 101 could jam, and potentially not close at all.

Similarly, if the near (first) axle 108 is too close to the body of the truck 104, that is, if dₜ₋₁ is too small, the tension force provided by spring 112 will be reduced, to that it could be almost as difficult to open the ramp 101. Meanwhile, if the near (first) axle 108 is too far from the body of the truck 104, it will interfere with the safe movement and operation of the ramp 100, and also interfere with or unbalance the effect of the springs 120_{L} , 120_{R}.

The spring 112 can be made from steel, although other materials are also contemplated within the spirit and scope of the present invention. The spring 112 is carefully calibrated to have a specific angle. If the angle is too small, the tension force and resulting lifting relief accorded by the spring 112 would be insufficient and thus would not help a person operate the ramp 101, so that it would still be necessary to apply hernia-level force to the handle 105. Meanwhile, if the angle of the spring 112 was too large, it would tend to always force the ramp 101 into a closed position, even when such an effect is not wanted by the user.

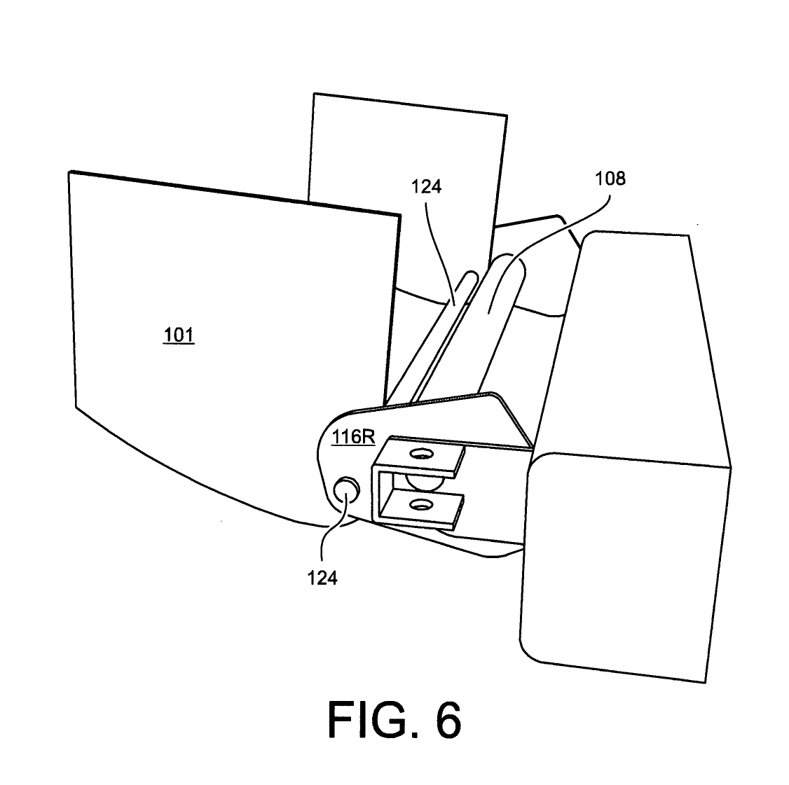

FIG. 6 shows more detail of the tipping point position of the ramp 101 first shown in FIG. 2B. FIG. 6 shows the function of the cams 116, although only the rightmost cam 116_{R} is shown. From FIG. 6 it is apparent that the cams 116 are connected to both the near and far axles 108, 124.

Using the opening of the ramp 101 from its closed position in FIG. 2A as an example, it becomes apparent that the system 100 first rotates the ramp 101 about the near axle 108. During this time, the spring 112 affects the operation of the ramp 101, while the springs 120_{L} and 120_{R} are not active. The cams 116_{L,R} assist in determining when that first rotation is complete. At the predetermined tipping point (FIGS. 2B, 6), the cams 116 transfer the rotary effect of the ramp 101 to the far axle 124. From there, rotation of the ramp 101 then continues until it reaches the position shown in FIG. 2C. During that time, the spring 112 does not affect the operation of the ramp 101, while the springs 120_{L} and 120_{R} are active.

The system 100 of the present invention assists in the smooth and easy operation of this rotation. Because all equipment involved in the process of using the ramp 101 is heavy, such as that used in agricultural equipment, the ramp 101 must bear a significant amount of weight. The loadbearing members of the ramp 101 thus weigh a significant amount, and once put into position must remain in that position. The downside of this is that the ramp 101 sometimes resists being moved from one position to another during opening and closing.

As demonstrated herein, the system 100 of the present invention provides a safety feature for users of the ramp 101. Otherwise, the ramp 101 could require an excessive amount of force to operate.

While the ramp 101 is in its closed position (FIG. 2A), its weight is compensated by the various springs within the system 100 of the present invention. Because of this, in its closed state, the ramp 101 has only minimal tension applied thereto. Accordingly, while driving, the ramp 100 can fly up, bounce, or go anywhere.

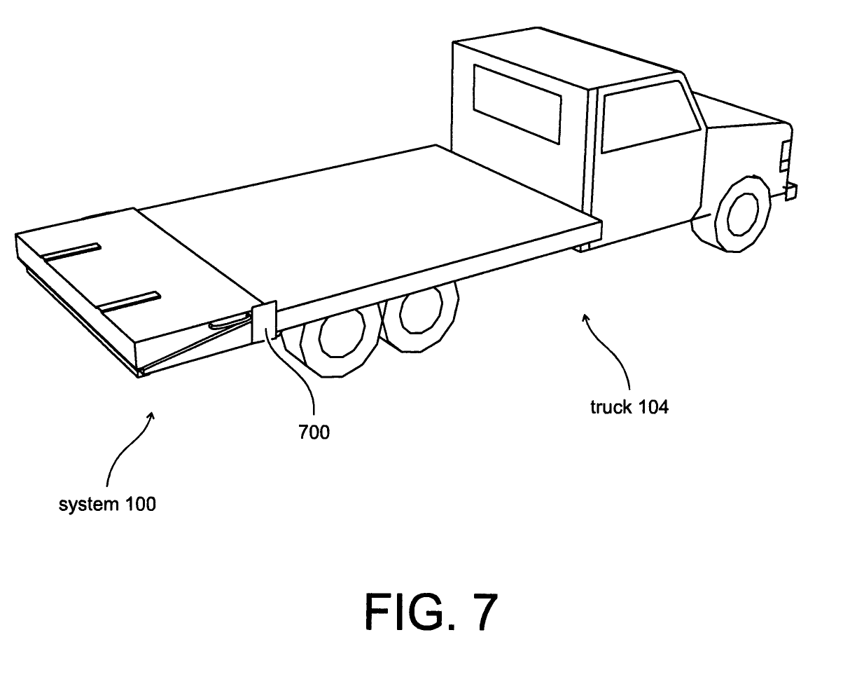

To address this problem, a latch 700 is shown in FIG. 7. However, although a latch is shown in FIG. 7, other securing mechanisms are also contemplated within the spirit and scope of the present invention.

It is anticipated that various changes may be made in the arrangement and operation of the system of the present invention without departing from the spirit and scope of the invention, as defined by the following claims.

What is claimed is:

1. A system for operating a ramp on a truck, comprising:
a movable ramp surface, rotatably joined to the truck by near and far axles;
a plurality of far springs, wrapped about the far axle, for controlling the tension between the ramp surface and the truck; and
a plurality of near springs, wrapped about the near axle, for controlling the tension between the truck and the far axle.

2. The system of claim 1, wherein a first end of the plurality of near springs touches the truck, and a second end of the plurality of near springs touches the far axle

3. The system of claim 2, further comprising:
the plurality of near springs have a predetermined angle that assists a person in operating the ramp, but not force the ramp into a closed position.

4. The system of claim 1, further comprising:
the ramp surface has three main positions of operation, open, closed, and tipping;

5. The system of claim 4, further comprising:
a pair of cams affixed to the ramp surface and also to the near and far axles such that the cams segue the rotation of the ramp surface from the near axle to the far axle, and return.

6. The system of claim 5, further comprising:
the pair of cams are positioned so as to determine when rotation of the ramp surface about the near axle has completed its travel from its closed position, indicate a tipping point of the ramp surface, transfer rotation of the ramp surface from the near axle to the far axle; and assist rotation of the ramp until it reaches a open position;

7. The system of claim 6, further comprising:
wherein the plurality of near springs act on the ramp surface during the time the ramp surface rotates from its closed position to the tipping point and return; and
the plurality of far springs do not act on the ramp surface during the time the ramp surface rotates from its closed position to the tipping point.

8. The system of claim 6, further comprising:
wherein the plurality of near springs do not act on the ramp surface during the time the ramp surface rotates from its tipping point to the open position and return; and
the plurality of far springs act on the ramp surface during the time the ramp surface rotates from its tipping point to the open position and return.

9. The system of claim 1, further comprising:
a latch, movably attachable to the ramp surface and the truck.

10. A method of opening a ramp, comprising:
removing a latch that fastens the ramp to a truck;
applying upward force to a handle attached to the ramp;
during the applying upward step, utilizing a beneficial force applied by a plurality of near springs;
arriving at a tipping point;
transferring rotation of the ramp from a near to a far axle;
applying horizontal force to the handle; thereby moving the ramp past the tipping point;
during the applying horizontal step, utilizing a beneficial force applied by a plurality of far springs; and
locating the ramp into an open position.

11. A method of closing a ramp, comprising:
applying upward force to a handle attached to the ramp;
during the applying upward step, utilizing a beneficial force applied by a plurality of far springs;
arriving at a tipping point;
transferring rotation of the ramp from a far to a near axle;
applying horizontal force to the handle; thereby moving the ramp past the tipping point;
during the applying horizontal step, utilizing a beneficial force applied by a plurality of near springs; and
locating the ramp into a closed position; and
applying a latch that fastens the ramp to a truck.

12. A method of constructing a ramp system, comprising:
fastening a near axle to a truck at a predetermined distance from that truck;
positioning the near axle the predetermined distance using a pair of cams having a predetermined spacing and width;
fastening a far axle to the pair of cams;
fastening a ramp to both axles, such that the ramp alternates between rotating about either the near or far axle but never both;
positioning a plurality of near springs about the near axle, such that the plurality of near springs physically contact both the far axle as well as the truck; and
positioning a plurality of far springs about the far axle, such that the plurality of far springs physically contact both the near axle as well as the ramp.
